(19) United States
(12) Patent Application Publication
(10) Pub. No.: US 2012/0092418 A1
(43) Pub. Date: Apr. 19, 2012

(54) SINGLE-NOZZLE INKJET HEAD

(75) Inventors: Shih-Chang Chen, Hsinchu (TW); Shih-Che Chiu, Hsinchu (TW); Tsung-Pat Chou, Hsinchu (TW)

(73) Assignee: MICROJET TECHNOLOGY CO., LTD, Hsinchu (TW)

(21) Appl. No.: 13/272,438

(22) Filed: Oct. 13, 2011

(30) Foreign Application Priority Data
Oct. 14, 2010 (CN) 201010517980.4

(51) Int. Cl. B41J 2/14

(52) U.S. Cl. 347/47

(57) ABSTRACT

A single-nozzle inkjet head includes a first chamber member and a second chamber member. The first chamber member has a first flow channel. The second chamber member is detachably connected with the first chamber member. The second chamber member includes a main body, a nozzle plate and an actuator. The main body has a second flow channel, wherein the second flow channel is in communication with the first flow channel for transporting a fluid. The nozzle plate is disposed on the main body, and has a nozzle. The actuator is disposed on the nozzle plate, and located around the nozzle.

### FIELD OF THE INVENTION

The present invention relates to an inkjet head, and more particularly to a single-nozzle inkjet head.

### BACKGROUND OF THE INVENTION

Nowadays, a single-nozzle piezoelectric inkjet head is widely used in a biochemistry medical laboratory instrument or industrial dispensing equipment. FIG. 1A is a schematic cross-sectional view illustrating a conventional single-nozzle piezoelectric inkjet head. As shown in FIG. 1A, the conventional single-nozzle piezoelectric inkjet head 1 comprises a main body 10, a nozzle plate 11 and an actuator 12. The main body 10 has a flow channel 101. The nozzle plate 11 has a nozzle 111. The actuator 12 is disposed on the nozzle plate 11. In addition, the actuator 12 is located around and symmetrical to the center of the nozzle 111. FIG. 1B schematically illustrates the relationship between the nozzle plate and the actuator of the single-nozzle piezoelectric inkjet head of FIG. 1A. As shown in FIG. 1B, two bonding pads 13 are disposed on the nozzle plate 11 and the actuator 12, respectively. Through the bonding pads 13, a first electrode 141 and a second electrode 142 are electrically connected with the bonding pads 13.

Please refer to FIG. 1A again. In the conventional single-nozzle piezoelectric inkjet head 1, the nozzle plate 11 is directly attached on the main body 10 and aligned with the flow channel 101. In a case that the nozzle plate 11 has a breakdown, the combination of main body 10 and the actuator 11 should be completely replaced. Since the way of only replacing the nozzle plate 11 is impossible, the operating cost is increased. Moreover, as shown in FIG. 1B, the bonding pads 13 are protruded from the nozzle plate 11 and the actuator 12. If the ejected ink droplets are adsorbed on the actuator 12, the electrodes are possibly short-circuited. For protecting the actuator 12, the surface of the actuator 12 needs to be coated with an isolation layer or an isolation gel. Since the bonding pad 13 is protruded from the surface of the actuator 12, it is difficult to apply the isolation layer or the isolation gel on the surface of the actuator 12.

Therefore, there is a need of providing an improved single-nozzle inkjet head in order to obviate the above drawbacks.

### SUMMARY OF THE INVENTION

The present invention provides a single-nozzle inkjet head. The single-nozzle inkjet head includes a first chamber member and a second chamber member. The first chamber member is detachably connected with the second chamber member. Moreover, a flexible printed circuit board is placed on the actuator to protect the actuator, so that the possibility of causing short-circuit between the electrodes will be minimized. Moreover, if the nozzle plate has a breakdown, the nozzle plate may be replaced by simply changing the second chamber member.

In accordance with an aspect of the present invention, there is provided a single-nozzle inkjet head. The single-nozzle inkjet head includes a first chamber member and a second chamber member. The first chamber member has a first flow channel. The second chamber member is detachably connected with the first chamber member. The second chamber member includes a main body, a nozzle plate and an actuator. The main body has a second flow channel, wherein the second flow channel is in communication with the first flow channel for transporting a fluid. The nozzle plate is disposed on the main body, and has a nozzle. The actuator is disposed on the nozzle plate, and located around the nozzle.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic cross-sectional view illustrating a conventional single-nozzle piezoelectric inkjet head;

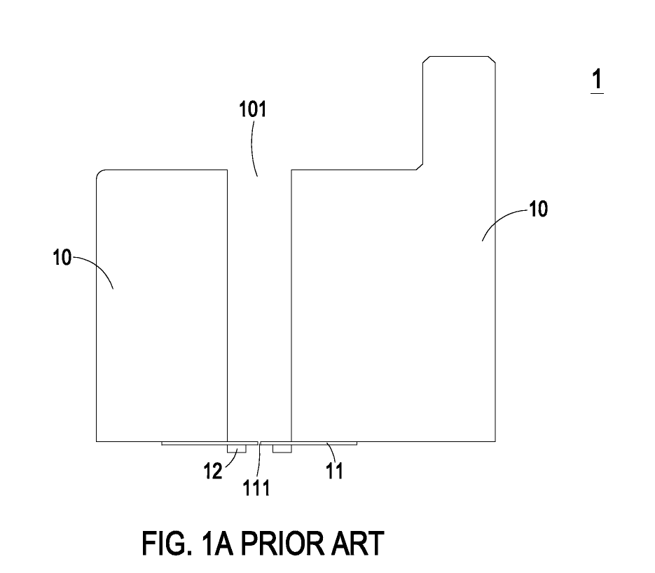

FIG. 1B schematically illustrates the relationship between the nozzle plate and the actuator of the single-nozzle piezoelectric inkjet head of FIG. 1A;

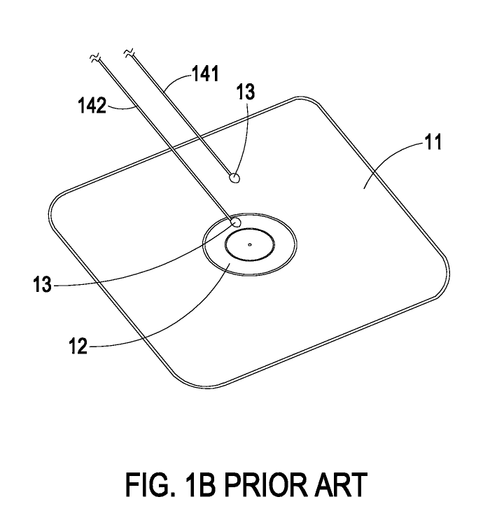

FIG. 2A is a schematic exploded view illustrating a single-nozzle inkjet head according to a first embodiment of the present invention;

FIG. 2B is a schematic cross-sectional view illustrating the single-nozzle inkjet head of FIG. 2A;

FIG. 3 is a schematic view illustrating the relationship between the flexible printed circuit board and the nozzle plate of the single-nozzle inkjet head of FIG. 2A;

FIG. 4A is a schematic exploded view illustrating a single-nozzle inkjet head according to a second embodiment of the present invention; and

FIG. 4B is a schematic cross-sectional view illustrating the single-nozzle inkjet head of FIG. 4A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

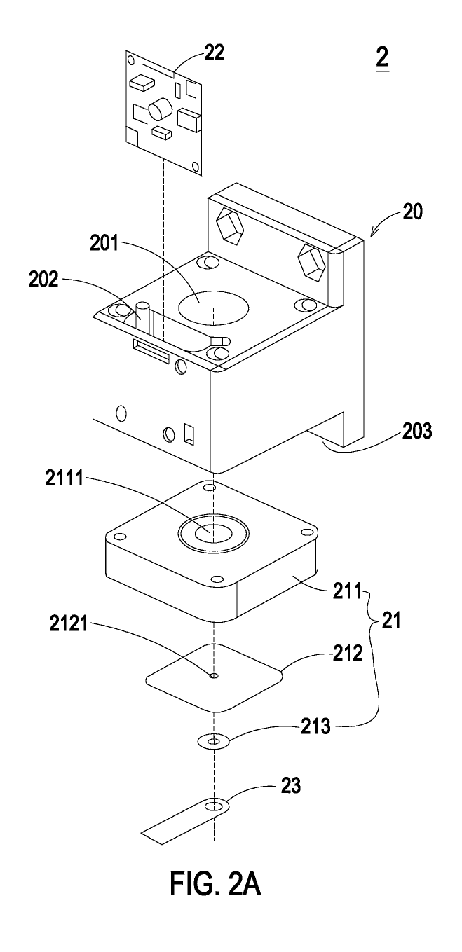

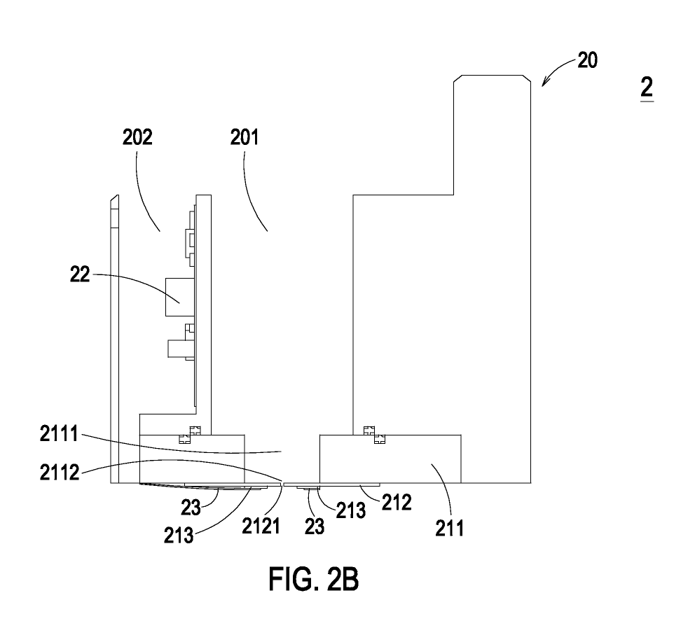

Please refer to FIGS. 2A and 2B. FIG. 2A is a schematic exploded view illustrating a single-nozzle inkjet head according to a first embodiment of the present invention. FIG. 2B is a schematic cross-sectional view illustrating the single-nozzle inkjet head of FIG. 2A. As shown in FIG. 2A, the single-nozzle inkjet head 2 comprises a first chamber member 20 and a second chamber member 21. The first chamber member 20 comprises a first flow channel 201, a receiving part 202 and a concave structure 203. The first flow channel 201 runs through the first chamber member 20. The receiving part 202 is located beside the first flow channel 201 for accommodating a driving circuit board 22. The concave structure 203 is located at the bottom of the first chamber member 20. Through the concave structure 203, the second chamber member 21 is connected with the first chamber member 20. The second chamber member 21 comprises a main body 211, a nozzle plate 212 and an actuator 213. The main body 211 has a second flow channel 2111. The second flow channel 2111 runs through the main body 211, and is in communication with the first flow channel 201. The nozzle plate 212 is directly disposed on the main body 211 and has a nozzle 2121. The nozzle 2121 is aligned with a flow channel outlet 2112 of the second flow channel 2111. An example of the actuator 213 is a piezoelectric element. The actuator 213 is disposed on the nozzle plate 212, and located around the nozzle 2121.

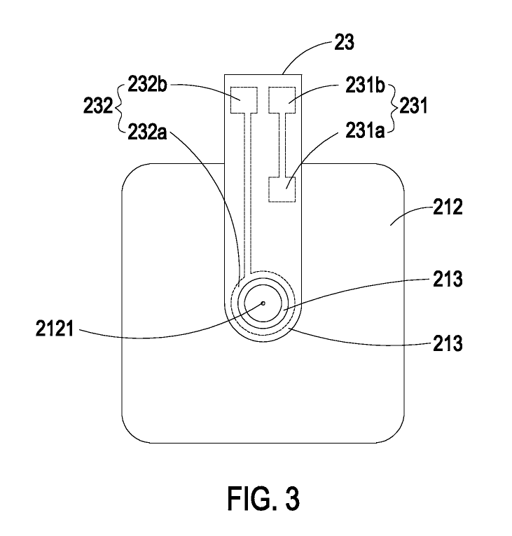

Moreover, the single-nozzle inkjet head 2 further comprises a flexible printed circuit board 23. The flexible printed circuit board 23 is disposed on the actuator 213. FIG. 3 is a schematic view illustrating the relationship between the flexible printed circuit board and the nozzle plate of the single-nozzle inkjet head of FIG. 2A. As shown in FIG. 3, the flexible printed circuit board 23 is disposed on a bottom surface of the actuator 213 for partially sheltering the actuator 213. The flexible printed circuit board 23 comprises a first electrode 231 and a second electrode 232. Moreover, the flexible printed circuit board 23 may be disposed on the actuator 213 in an attaching, adhering or welding manner. The first electrode 231 and the second electrode 232 are planar electrodes. The first electrode 231 has a first terminal 231a and a second terminal 231b. The second electrode 232 has a first terminal 232a and a second terminal 232b. The first terminal 231a of the first electrode 231 is connected with the nozzle plate 212. The first terminal 232a of the second electrode 232 is connected with the actuator 213. The second terminal 231b of the first electrode 231 and the second terminal 232b of the second electrode 232 are connected with the driving circuit board 22.

After the single-nozzle inkjet head 2 is enabled, a driving voltage is transmitted from the driving circuit board 22 to the flexible printed circuit board 23. In response to the driving voltage, the actuator 213 is triggered to drive the nozzle plate 212. Consequently, the fluid within the second flow channel 2111 of the second chamber member 21 is ejected out through the nozzle 2121. Moreover, the first electrode 231 and the second electrode 232 of the flexible printed circuit board 23 are completely attached on the bottom surface of the nozzle plate 212 and the bottom surface of the actuator 213. Consequently, the actuator 213, the first electrode 231 and the second electrode 232 can be protected by the flexible printed circuit board 23, and the first electrode 231 and the second electrode 232 can be guided to the driving circuit board 22 and electrically connected with the driving circuit board 22. In such way, it is not necessary to apply an isolation layer or an isolation gel on the surface of the actuator, and the possibility of causing the short-circuited problem will be minimized.

Please refer to FIGS. 2A and 2B again. As shown in FIG. 2A, the second chamber member 21 is detachably connected with and disposed on the concave structure 203 of the first chamber member 20. The first chamber member 20 and the second chamber member 21 may be connected with each other by a screwing means or a fastening means. Consequently, the first flow channel 201 and the second flow channel 2111 are in communication with each other, and the bottom of the first chamber member 20 and the bottom of the second chamber member 21 are coplanar (see FIG. 2B). Under this circumstance, if the nozzle plate 212 has a breakdown, the nozzle plate 212 may be replaced by simply changing the second chamber member 21. Moreover, according to the practical requirements, the original second chamber member 21 may be replaced with a new one that has different size of nozzle 2121 or actuator 213. Consequently, the single-nozzle inkjet head 2 is not restricted to the sizes of the nozzle plate 212 and the actuator 213. By changing the second chamber member 21, the single-nozzle inkjet head 2 with a desired size of the nozzle 2121 or a desired size of the actuator 213 can be quickly acquired. Due to the above benefits, the single-nozzle inkjet head 2 is suitably applied to the industrial applications requiring XYZ-axis precise moving platform. For example, the single-nozzle inkjet head 2 can be applied to flux injection, dispensing, fabrication of liquid crystal display, rapid prototyping, electrical trace printing, or the like.

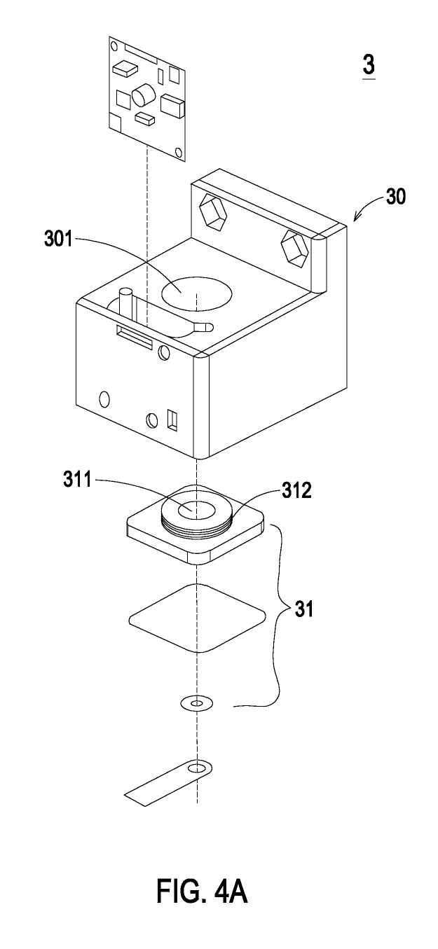

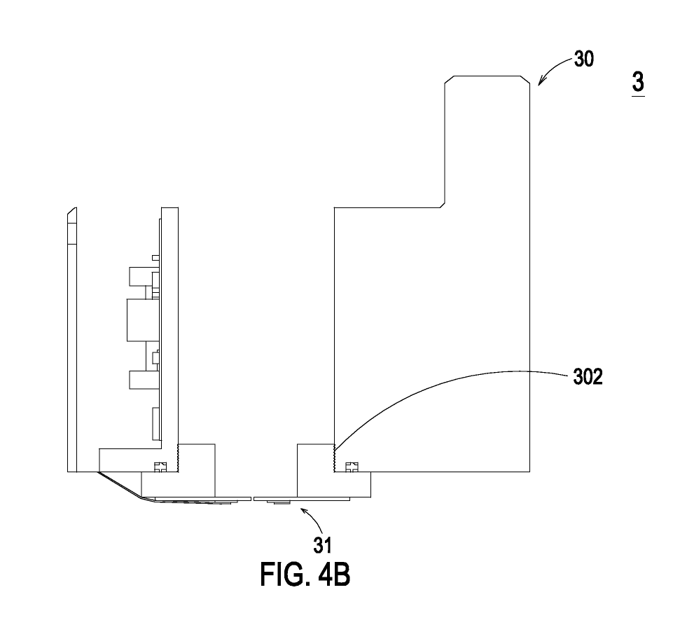

Moreover, numerous modifications and alterations of the second chamber member may be made while retaining the teachings of the invention. FIG. 4A is a schematic exploded view illustrating a single-nozzle inkjet head according to a second embodiment of the present invention. FIG. 4B is a schematic cross-sectional view illustrating the single-nozzle inkjet head of FIG. 4A. In the single-nozzle inkjet head 3 of this embodiment, a male thread structure is formed on the inner wall 302 and the distal end of the first flow channel 301 (see FIG. 4B) and a female thread structure is formed on an outer wall 312 of the second flow channel 311 (see FIG. 4A). By rotating the second chamber member 31 relative to the first chamber member 30, the first chamber member 30 and the second chamber member 31 can be either engaged with each other or disconnected from each other.

From the above description, the present invention provides a single-nozzle inkjet head with a first chamber member and a second chamber member. The first chamber member and the second chamber member are detachably connected with each other. The user can replace the nozzle plate or the actuator by simply changing the second chamber member. Moreover, according to the practical requirements, the original second chamber member may be replaced with a new one that has different size of nozzle or actuator. Consequently, the utilization flexibility of the single-nozzle inkjet head is enhanced, and the operating cost is reduced. Moreover, by means of the flexible printed circuit board, the first electrode and the second electrode can be completely attached on the bottom surface of the nozzle plate and the bottom surface of the actuator. Consequently, the actuator, the first electrode and the second electrode can be protected by the flexible printed circuit board, and the first electrode and the second electrode can be guided to the driving circuit board and electrically connected with the driving circuit board. Since the protruded heights of the first electrode and the second electrode are reduced, the possibility of causing short-circuit between the electrodes will be minimized.

In views of the above benefits, the single-nozzle inkjet head of the present invention is advantageous over the conventional single-nozzle inkjet head.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A single-nozzle inkjet head, comprising:
a first chamber member having a first flow channel; and
a second chamber member detachably connected with said first chamber member, and comprising:
a main body having a second flow channel, wherein said second flow channel is in communication with said first flow channel for transporting a fluid;
a nozzle plate disposed on said main body, and having a nozzle; and
an actuator disposed on said nozzle plate, and located around said nozzle.

2. The single-nozzle inkjet head according to claim 1 wherein said first chamber member further comprises a receiving part and a concave structure, wherein said receiving part is located beside said first flow channel for accommodating a driving circuit board, and said concave structure is located at a bottom of said first chamber member, wherein said second chamber member is connected with said first chamber member through said concave structure.

3. The single-nozzle inkjet head according to claim 1 wherein said nozzle is aligned with a flow channel outlet of said second flow channel.

4. The single-nozzle inkjet head according to claim 1 wherein said second chamber member is in communication with said first chamber member, wherein a first thread structure is formed on an inner wall and a distal end of said first flow channel, and a second thread structure is formed on an outer wall of said second flow channel, wherein when said first thread structure and said second thread structure are engaged with each other, said first chamber member and said second chamber member are connected with each other.

5. The single-nozzle inkjet head according to claim 1 further comprising a flexible printed circuit board, which is disposed on said actuator, wherein said flexible printed circuit board has plural electrodes, which are respectively connected with said actuator and said nozzle plate.

6. The single-nozzle inkjet head according to claim 5 wherein said flexible printed circuit board is attached on said actuator, so that said actuator is protected by said flexible printed circuit board.

7. The single-nozzle inkjet head according to claim 6 wherein said plural electrodes of said flexible printed circuit board are planar electrodes, and comprise a first electrode and a second electrode.

8. The single-nozzle inkjet head according to claim 7 wherein a first terminal of said first electrode is connected with said nozzle plate, a first terminal of said second electrode is connected with said actuator, and a second terminal of said first electrode and a second terminal of said second electrode are connected with a driving circuit board.
